(19) United States
(12) Patent Application Publication
(10) Pub. No.: US 2024/0111955 A1
(43) Pub. Date: Apr. 4, 2024

(54) Named Entity Disambiguation Using Capsule Networks

(71) Applicant: Cognizer, Inc., Pleasanton, CA (US)

(72) Inventors: Suzanne M Kirch, Waltham, MA (US); Vineeth Thanikonda Munirathnam, Bangalore (IN); Rajiv Baronia, San Ramon, CA (US); Jack Porter, Valley Springs, CA (US)

(21) Appl. No.: 18/276,435

(22) PCT Filed: Feb. 9, 2022
(86) PCT No.: PCT/US22/15721

§ 371 Date: Aug. 8, 2023

(51) Int. Cl. G06F 40/295; G06F 40/284; G06N 3/09

(52) U.S. Cl. CPC G06F 40/295; G06F 40/284; G06N 3/09

(57) ABSTRACT

Named Entity Disambiguation is the process of identifying unique entities within a document. The disclosed invention leverages the CapsNet architecture for improved NED, which in the preferred embodiment includes NER. This is done by deriving the features of an input text, which are used to identify, classify, and disambiguate any named entities in the text. The system is further configured to identify named entities in the text and perform clustering to group named entities. Named entities are disambiguated to identify which named entity the text refers to uniquely. The disclosed CapsNet considers the context of the whole text to activate higher capsule layers in order to identify, classify, and disambiguate named entities.

### CROSS REFERENCE TO RELATED APPLICATIONS

This application claims priority from provisional U.S. patent application No. 63/148,129 filed on Feb. 10, 2021.

### FIELD OF THE INVENTION

Embodiments of the invention generation relate to natural language processing, more particularly to the usage of capsule networks for named entity disambiguation.

### BACKGROUND

Semantic parsing is the task of transforming natural language text into a machine readable formal representation. Natural language processing (NLP) involves the use of artificial intelligence to process and analyze large amounts of natural language data. Named Entity Recognition (NER) is the identification and classification of named entities within a document. Traditionally, an NER model identifies a named entity (NE) as belonging to a class in a predefined set of classes. Possible classifications of named entities in different NER models include person, location, artifact, award, media, team, time, monetary value, etc. Named Entity Disambiguation (NED) is the process of identifying unique entities within a document. This includes recognizing name variations where the same entity can appear in different forms, such as abbreviations, aliases, or even spelling variations and errors, illustrated by “John” and “John Smith.” Additionally, it requires distinguishing between different entities with the same name, such as multiple persons named “John Smith.” NER and NED models can be used to identify how to correctly handle data in a given document based on a specific named entity or named entity class.

Common NER models utilize a Bidirectional Long Short Term Memory (BiLSTM) encoder and Conditional Random Field (CRF) decoder. Bidirectional LSTMs consist of a pair of LSTMs, where one is trained from left-to-right (forward) and the other is trained from right-to-left (backward). However, because they are two separate LSTMs, neither of them look at both directions at the same time and thus are not truly bidirectional. Each LSTM can only consider the context on one side of the named entity at a time. The model is not able to consider the full context of the named entity to efficiently determine the correct class that the named entity belongs to. Other previous methods of NER and NED include contextual word embeddings from Bidirectional Encoder Representations from Transformers (BERT), Embeddings from Language Models (ELMo), and Flair. One model utilizes the concept of masking from BERT, creating what it describes as masked entity prediction, to predict masked entities sequentially in entity annotated texts. Another NED model is a neural network model that jointly learns distributed representations of texts and knowledge base entities.

A major shortcoming of these models includes their inability to consider and understand semantic features. While some models may use some form of features, these models assume that the model will pick up the grammar features as it attempts to find patterns. Additionally, models generally perform standard NER or NED, not both. Lastly, these models are typically limited to a small set of predefined named entity classes.

Capsule Neural Networks (CapsNet) are machine learning systems that model hierarchical relationships. CapsNets were introduced in the image classification domain, where they are configured to receive as input an image and to process the image to perform image classification or object detection tasks. CapsNet improves on Convolutional Neural Networks (CNN) through the addition of the capsule structure and is better suited to outputting the orientation of an observation and pose of an observation compared to CNN. Thus, it can train on a comparatively lesser number of data points with a better performance in solving the same problem. The dynamic routing algorithm groups capsules together to activate higher level parent capsules. Over the course of iterations, each parents' outputs may converge with the predictions of some children and diverge from those of others, thus removing a lot of unnecessary activations in the network, ultimately until the capsules reach an agreement.

### SUMMARY

Named Entity Disambiguation is the process of identifying unique entities within a document. The disclosed invention leverages the CapsNet architecture for improved NED, which in the preferred embodiment includes NER. This is done by deriving the features of an input text, which are used to identify, classify, and disambiguate any named entities in the text. The system is further configured to identify named entities in the text and perform clustering to group named entities. Named entities are disambiguated to identify which named entity the text refers to uniquely. The disclosed CapsNet considers the context of the whole text to activate higher capsule layers in order to identify, classify, and disambiguate named entities.

A computer-implemented method for disambiguating named entities in a natural language text is provided. This includes receiving, into a neural capsule embedding network as input, an embedding matrix, where the embedding matrix contains embeddings representing words in a natural language text and each row in the matrix is an embedding sentence, analyzing, by the neural capsule embedding network, the features of each word in context of the embedding matrix considering tokens to the left and right of the word and the sentences before and after the sentence of the word using at least one layer, each layer consisting of at least one set of filters, through dynamic routing of capsules, by the neural capsule embedding network, converging to a final capsule layer mapping to each word in the input matrix, generating, by the neural capsule embedding network, an output matrix, wherein each output matrix value identifies if a word in the input is a named entity or not a named entity, and if the word is a named entity, identifies a unique ID number of the entity. The classes can be a predefined set of named entity classes or clusters determined by the neural capsule embedding network.

The input can be a natural language text, where the words in the natural language text are converted into embeddings and inserted into an embedding matrix during pre-processing. The features of the natural language text can be identified during pre-processing. The features can be included in the embedding marix as feature embeddings. The features can also be identified by the Neural Capsule Embedding Network.

### BRIEF DESCRIPTION OF THE DRAWINGS

The accompanying drawings taken in conjunction with the detailed description will assist in making the advantages and aspects of the disclosure more apparent.

FIG. 1 depicts a system configured to identify, classify, and disambiguate named entities in a natural language input.

FIG. 2 depicts a Named Entity Disambiguator embodiment configured to identify, classify, and disambiguate named entities in a natural language input.

FIG. 3 depicts words in an input text converted to numerical representations called embeddings.

FIG. 4 depicts a filter within a layer of a Neural Capsule Entity Disambiguator.

FIG. 5 depicts a process by which a filter operates on a padded matrix to produce a matrix.

FIGS. 6A and 6B depict matrices used in the filter operation process depicted in FIG. 5.

FIG. 7 depicts the dynamic routing of capsules.

FIG. 8 depicts a matrix output of a Named Entity Disambiguator.

FIG. 9 depicts an alternative matrix output of a Named Entity Disambiguator.

FIG. 10 depicts a vector output of a Named Entity Disambiguator.

FIG. 11 depicts an alternative Named Entity Disambiguator embodiment configured to identify, classify, and disambiguate named entities in a natural language input.

### DETAILED DESCRIPTION OF THE INVENTION

Reference will now be made in detail to the present embodiments discussed herein, illustrated in the accompanying drawings. The embodiments are described below to explain the disclosed method, system, apparatus, and program by referring to the figures using like numerals.

The subject matter is presented in the general context of program modules and/or in computer hardware, including the structures disclosed in this specification and their structural equivalents, or in combinations of one or more of them. Those skilled in the art will recognize that other implementations may be performed in combination with other types of program and hardware modules that may include different data structures, components, or routines that perform similar tasks. The invention can be practiced using various computer system configurations and across one or more computers, including, but not limited to, clients and servers in a client-server relationship. Computers encompass all kinds of apparatus, devices, and machines for processing data, including by way of example one or more programmable processors, memory, and can optionally include, in addition to hardware, computer programs and the ability to receive data from or transfer data to, or both, mass storage devices. A computer program, which may also be referred to or described as a program, software, a software application, an app, a module, a software module, a script, or code, can be written in any form of programming language, including compiled or interpreted languages, or declarative or procedural languages; it can be deployed in any form, including as a stand-alone program or as a module, component, subroutine, or other unit suitable for use in a computing environment deployed or executed on one or more computers.

Unless otherwise defined, all terms (including technical and scientific terms) used herein have the same meaning as commonly understood by one having ordinary skill in the art to which this invention belongs. In describing the invention, it will be understood that a number of techniques and steps are disclosed. Each of these has individual benefits, and each can also be used in conjunction with one or more, or in some cases all, of the other disclosed techniques. Accordingly, for the sake of clarity, this description will refrain from repeating every possible combination of the individual steps in an unnecessary fashion. The specification and claims should be read with the understanding that such combinations are entirely within the scope of the invention and the claims.

It will nevertheless be understood that no limitation of the scope is thereby intended, such alterations and further modifications in the illustrated invention, and such further applications of the principles as illustrated therein being contemplated as would normally occur to one skilled in the art to which the embodiments relate. The present disclosure is to be considered as an exemplification of the invention, and is not intended to limit the invention to the specific embodiments illustrated by the figures or description below.

System, method, apparatus, and program instruction for Named Entity Disambiguation using Capsule Networks is provided. Such an invention allows for the more efficient processing of natural language data. The disclosed invention leverages the CapsNet architecture for improved NED, which in the preferred embodiment includes NER. This is done by deriving the features of an input text, which are used to identify, classify, and disambiguate any named entities in the text. The system is further configured to identify named entities in the text and perform clustering to group named entities. Clustering allows for the creation of new named entity classes that might have been previously missed and the splitting of existing classes to classify named entities more specifically. Named entities are disambiguated to identify which named entity the text refers to uniquely. An explanation for identifying, classifying, and disambiguating named entities in the context of a text using CapsNet follows. The principles discussed herein can be applied to a model that performs NED without NER.

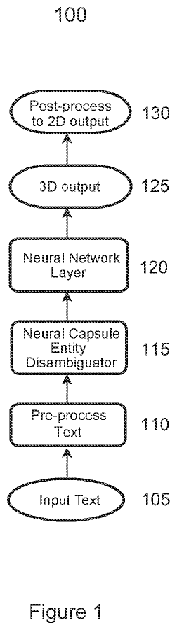

As illustrated in FIG. 1, a disclosed system 100, configured to identify, classify, and disambiguate named entities, is provided. Such a system can have installed on it software, firmware, hardware, or a combination of them that in operation causes the system to perform operations or actions. The system receives a natural language input 105 stored in memory or accessed from another computer. This disclosure contemplates different natural language text lengths and formats as input.

In the preferred embodiment, the input is pre-processed 110, using different NLP libraries to identify features of the natural language text that will be provided to and used by the model. This includes linguistic and semantic features of the text. Instead of assuming that the model can pick up all features on its own, the inclusion of linguistic features in the capsules ensures that the model can use all of the features to better disambiguate named entities in the text. The text is fed through parsers to determine these NED features, including, but not limited to, part of speech tags and dependency relations. In the preferred embodiment, where NER is performed along with NED, there are three subsets of features: the above described features for NE disambiguation, features for NE identification, and features for NE classification. NE identification features include, but are not limited to, part of speech tags, constituency parsing, relations between words, and conjunctions. NE classification features include, but are not limited to, dependency relations, prepositions, and object types. These features are also determined during pre-processing. In other embodiments, where NED is performed separately from NER such that named entities and the classes to which they belong are already known, this information can be inputted as capsule features to perform NED. In embodiments that perform NED without NER, many of the NE identification and classification features may still be used as part of NED.

The input is split into sentences as determined by the system through punctuation or other means. A sentence can be further split into multiple rows of sentence fragments based on sentence structure and punctuation. It is understood that the use of sentences, for the purpose of this disclosure, can further include and refer to sentence fragments, rather than full sentences, and no limitation is intended. Each sentence is inserted into a row in a two dimensional matrix. After receiving the input matrix, the Neural Capsule Entity Disambiguator 115 uses at least one layer, with each layer consisting of at least one set of filters, and the derived features to identify, classify, and disambiguate the named entities in the text. The output is a three dimensional matrix of dimensions M×N×defined maximum number of named entity classes, as per the preferred embodiment. The Neural Network Layer 120 performs post-processing on the three dimensional matrix. The three dimensional matrix 125 is converted to a final two dimensional output 130, where the dimensions are the defined maximum number of named entity classes x input string length. Alternatively, the three dimensional matrix 125 can be converted to a final two dimensional output 130, where the dimensions are the number of named entity classes identified in the input text by the model x input string length. Each value in the matrix will be a non-zero value if it is a named entity, where the value will be the entity's unique ID number, and its position in the matrix is based on the named entity's location in the string and the cluster to which it belongs. In embodiments where NED is performed without prior or simultaneous performance of NER, a vector can be used, where each value will be a non-zero value if it is a named entity, where each value is the entity's unique ID number, and its position in the vector is based on the named entity's location in the string.

While the disclosed model supports a predefined set of named entity classes, the preferred embodiment supports a defined maximum number of undefined classes, termed clusters in this disclosure. The preferred embodiment has a defined maximum of 1000 clusters, which correspond to 1000 rows in the output 130. A smaller defined maximum number of clusters will result in clusters similar to traditional models and will result in a smaller output matrix. A larger defined maximum number of clusters will result in a finer level of granularity in the classification of named entities, as compared to traditional NER models. No limitation on the defined maximum number of clusters is intended.

In the preferred embodiment, IDs are integer values that are unique in the entire system. In alternative embodiments, IDs may be unique within each named entity class. Thus, in such alternative embodiments, entities in different classes can have the same ID, whereby the named entity is uniquely identified in the system using both the class and its ID within the class. Because the preferred embodiment performs clustering to create new classes or split existing classes, IDs being unique in the entire system is preferred, such that the ID may be used by itself to uniquely identify a named entity throughout the system, though no limitation is intended.

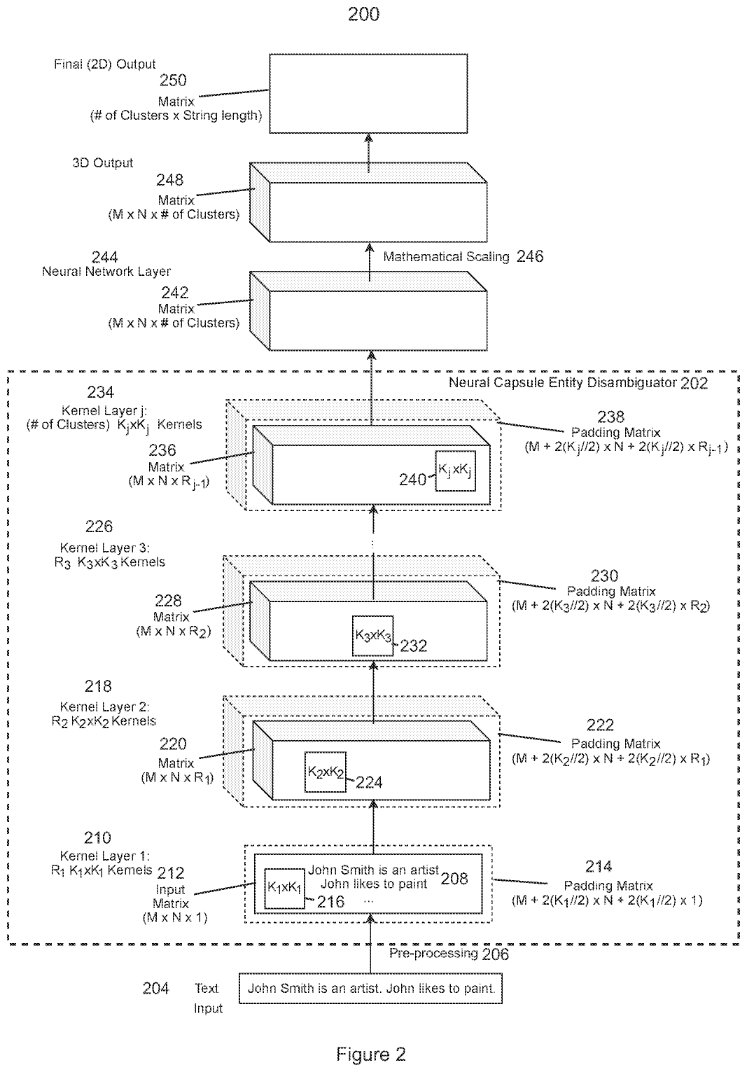

As illustrated in FIG. 2, a Named Entity Disambiguator embodiment 200, configured to identify, classify, and disambiguate named entities, is provided. A Named Entity Disambiguator, appropriately configured in accordance with this specification, can perform the disclosed processes and steps. An embodiment of the Named Entity Disambiguator can include a Neural Capsule Entity Disambiguator 202 and a Neural Network Layer 244. The processes and steps described below can be performed by one or more computers or computer components or one or more computer or computer components executing one or more computer programs to perform functions by operating on input and generating output.

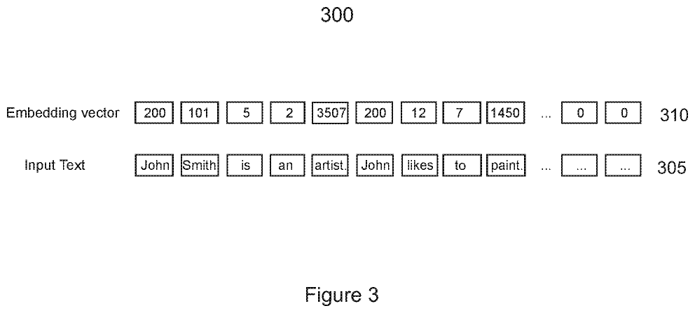

The Neural Capsule Entity Disambiguator 202, a neural capsule embedding network, is configured to receive a natural language text 204 as input in the depicted embodiment. Natural language text is comprised of one or more words, exemplified by the sentences, “John Smith is an artist. John likes to paint.” The input in the depicted embodiment is an example, and no limitation is intended. Because neural networks cannot read and understand text, the data is converted into numerical representations called embeddings during pre-processing 206. As illustrated in FIG. 3, the process 300 whereby each word in the input (“John Smith is an artist. John likes to paint.”) 305 passed to a Neural Capsule Entity Disambiguator is first converted to embeddings 310 is provided. In the preferred embodiment, the Neural Capsule Entity Disambiguator is designed to accept a vector length of 512 embeddings (I_{L}), though no limitation is intended. When receiving an input less than 512 words in length, embeddings following the text (that do not correspond to a word) are populated with the value of zero. Thus, for the example input, “John Smith is an artist. John likes to paint,” 9 embeddings having values corresponding to the words and 503 embeddings having value 0, comprise the embedding vector. This disclosure contemplates Neural Capsule Entity Disambiguators having different maximum and minimum length embedding vectors and those capable of receiving variable length embedding vectors. This disclosure contemplates the conversion of natural language data 305 to embeddings 310 by the Neural Capsule Entity Disambiguator or as part of pre-processing where the Neural Capsule Entity Disambiguator would receive the embedding vector as input. The conversion of natural language data to embeddings can be local to the Neural Capsule Entity Disambiguator 202 or separate. The format of the embedding vector can vary to additionally include other values that the system may use (with appropriate delimiters) but should contain the words of the input natural language text as embedding tokens. In the preferred embodiment, each word embedding in the embedding vector is itself a vector

Embodiments can vary in whether the features, to be evaluated by the Neural Capsule Entity Disambiguator, are identified during pre-processing or by the Neural Capsule Entity Disambiguator itself. In the preferred embodiment, the features of the text are identified during pre-processing and fed into the NED model. The features are converted to numerical representations and included with each word embedding that the feature is relevant to, as feature embeddings, where each embedding in the embedding vector is itself a vector. The feature embeddings in the embedding vector will be in the same order for each word. For each word, any feature embeddings for features that are not relevant to a word are populated with the value of zero in order for the embedding vector for each word to be the same dimension. Alternatively, the features can be identified in the first step in the capsule network.

The embedding vector is converted to a two dimensional input 208, where each sentence is inserted into a row. This results in an embedding matrix of dimensions M×N, where M is the maximum number of sentences and N is the maximum sentence length that the system is configured to receive. However, no limitation of scope, regarding the size of the embedding matrix or the ability of the model to receive a variable size matrix, is intended. In the preferred embodiment, if an embedding sentence in the embedding matrix is shorter than length N, embeddings following the end of the sentence are populated with the value of zero. If the number of embedding sentences is less than M, rows following the last sentence are populated with the value of zero. Because of variations in sentence length and the need to accommodate them, the product MN is larger than input vector length I_{L}. Thus, for the example input, “John Smith is an artist. John likes to paint,” the sentence, “John Smith is an artist,” is inserted into the first row, and the sentence, “John likes to paint,” is inserted into the second row. Embeddings following the end of the sentences in the first and second rows are populated with the value of zero for the rest of the row. Embedding sentences following the second (and final) sentence are populated with the value of zero for the entirety of the remaining rows. The M×N matrix is converted into a three dimensional M×N×R matrix, where R is 1. This disclosure contemplates the conversion of the embedding vector to the embedding matrix by the Neural Capsule Entity Disambiguator or as part of pre-processing where the Neural Capsule Entity Disambiguator would receive the embedding matrix as input. The conversion of the embedding vector to the embedding matrix can be local to the Neural Capsule Entity Disambiguator 202 or separate. The format of the embedding matrix can vary to additionally include other values that the system may use (with appropriate delimiters) but should contain the words of the input natural language text as embedding tokens. Furthermore, the natural language text input can be split into a two dimensional format before or at the same time as the conversion of the text to embeddings to create the embedding matrix without the use of an intermediate embedding vector.

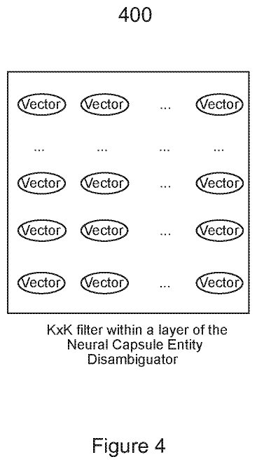

A Neural Capsule Entity Disambiguator 202 has layers of sets of Kᵢ×Kᵢ filters that will pass over the entire M×N×R matrix, where the Kᵢ filter size varies at each layer. In the first layer, R is 1, and in all other layers, R is the number of filters of the previous layer. As depicted in FIG. 4, a K×K filter 400, comprised of vectors, within a layer of the Neural Capsule Entity Disambiguator, is provided. Each entry in each vector of the K×K filter is randomly initialized. Each K×K filter will run through the full depth of the M×N×R matrix creating one layer of depth in the next M×N×R output. Each entry in the M×N×R matrix is a capsule that keeps track of the embedding of the word, features of the word, and any other calculations performed with the filters. In the preferred embodiment, an increasing number of filters operates on the matrix at each successive layer in the Neural Capsule Entity Disambiguator. The number of layers and the number of filters at each layer can vary and is configured to prevent saturation of the network while still assembling enough context and information to perform NED. The final layer of filters will have the same number of filters as the defined maximum number of clusters such that the final output is a three dimensional matrix of dimensions M×N×defined maximum number of clusters. This disclosure contemplates the performance of NED without NER. In such an embodiment, the defined maximum number of clusters would still be a hyperparameter that determines the number of filters used by the model, even though the creation of named entity clusters would not take place.

Before each set of Kᵢ×Kᵢ filters operates on the matrix, padding will be added around the M×N dimensions of the matrix, where the size of the padding on each side of the matrix is Kᵢ//2, where // is floor division. Floor division is a division-like operation that returns the largest possible integer less than or equal to the quotient in standard division, such that 10//3=3. When filters operate on a matrix, the resulting matrix decreases in size, which can result in a loss of data. The padding is added through the full depth of the three dimensional matrix, to ensure that the M×N dimensions of the matrix never change size at any layer. The dimensions of the matrix with padding is M+2(Kᵢ//2)×N+2(Kᵢ//2)×R, where R is either 1 (as in the very first layer) or the number of filters of the previous layer. Note that 2(Kᵢ//2) is Kᵢ when Kᵢ is an even number and Kᵢ−1 when Kᵢ is an odd number.

Different types of padding can be utilized to keep the M×N dimensions of the matrix constant at each layer. Constant padding pads the matrix with a constant value on each side. Zero is commonly used in constant padding, often referred to as zero padding. However, zero padding tends to dilute information on the edges of the matrix. Alternative forms of padding, like reflection and replication padding, can be utilized. These forms of padding are preferred since the padding is dependent on values in the M×N×R matrix. No limitation in the type of padding utilized is intended.

As depicted in FIG. 2, a series of Kᵢ×Kᵢ filters (kernels) operate on the M×N×R matrix. At the first layer 210, the input M×N×1 matrix 212 is padded to be M+2(K₁//2)×N+2(K₁//2)×1 214, where K₁ is both dimensions of the filters at the first layer. R₁ K₁×K₁ filters 216 operate on the matrix resulting in a matrix of dimensions M×N×R₁, where R₁ is the number of filters at the first layer. At the second layer 218, the M×N×R₁ matrix 220 is padded to be M+2(K₂//2)×N+2(K₂//2)×R₁ 222, where K₂ is both dimensions of the filter. R₂ K₂×K₂ filters 224 operate on the matrix resulting in a matrix of dimensions M×N×R₂, where R₂ is the number of filters at the second layer. At the third layer 226, the M×N×R₂ matrix 228 is padded to be M+2(K₃//2)×N+2(K₃//2)×R₂230, where K₃ is both dimensions of the filter. R₃ K₃×K₃ filters 232 operate on the matrix resulting in a matrix of dimensions M×N×R₃, where R₃ is the number of filters at the third layer. This process continues for each layer in the Neural Capsule Entity Disambiguator as an increasing number of filters operate on the matrix at each layer. At the final layer 234, the j^{th} layer, the M×N×Rⱼ₋₁ matrix 236 is padded to be M+2(Kⱼ//2)×N+2(Kⱼ//2)×Rⱼ₋₁ 238, where Kⱼ is both dimensions of the filters in the last layer. Kⱼ×Kⱼ filters 240 operate on the matrix, where the number of filters at the final layer is equal to the defined maximum number of clusters, resulting in a matrix of dimensions M×N×defined maximum number of clusters 242.

The network is trained on a corpus of text to produce this output matrix. Training is done by passing a known input, generating an output using the network as it currently is, then comparing it to the known correct output and modifying the parameters (weights) accordingly to improve the accuracy of the results. In the preferred embodiment, the capsules and capsule connections are randomly initialized. Over time, the network is trained to generate the known output for all natural language data input. Training can be supervised, with respect to the NER functionality of the model, whereby there is a predefined set of named entity classes, and the system is configured to group any recognized named entities into the appropriate class and identify them with an ID. The training can also be supervised, with respect to the NED functionality of the model, whereby there is a knowledge base of recognized entity IDs, and the system is configured to specifically identify and disambiguate named entities using the set of IDs. In the preferred embodiment, training is fully unsupervised, whereby there is a defined maximum number of clusters, and the system is configured to group any recognized named entities into as yet unidentified clusters and assign the recognized named entities an as yet unidentified ID. The clusters can later be identified during some form of post-processing. Similarly, the entity IDs can later be identified during some form of post-processing.

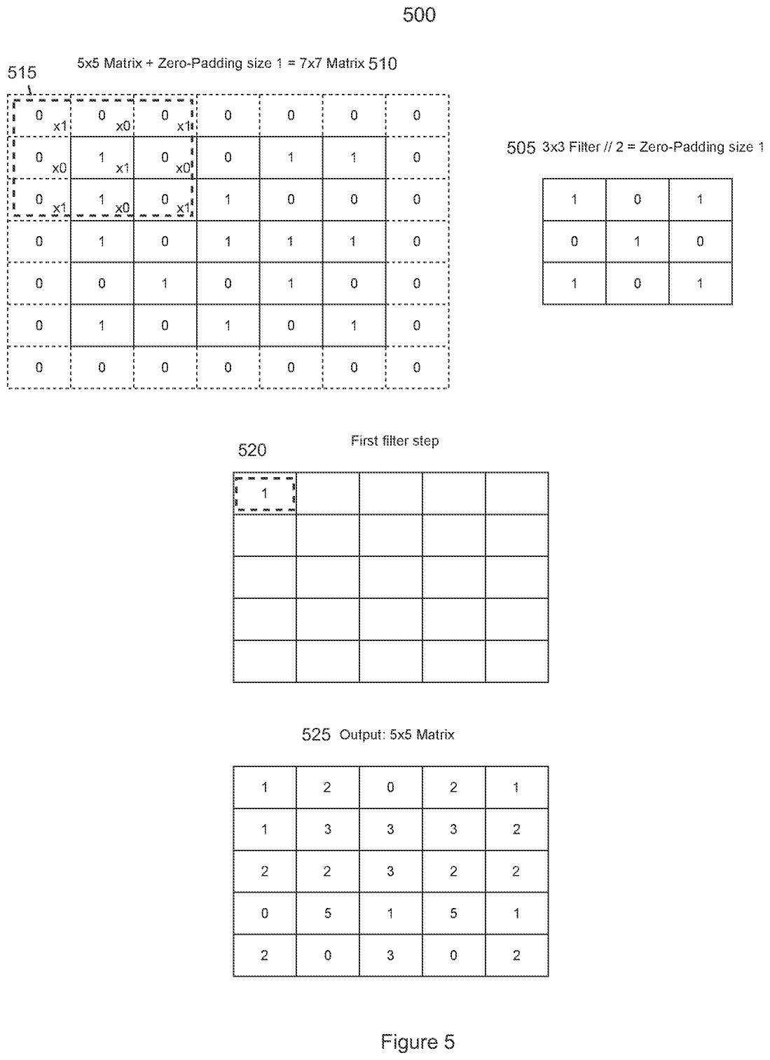

As illustrated in FIG. 5, the process 500 of a filter operating on a matrix is provided. In the depicted example, the 5×5 matrix is made up of 5 sentences having a maximum sentence length of 5, though natural language inputs will generally be larger. A 3×3 filter 505 is depicted even though the filter size will generally be larger than 3×3. The filter operates on a 3×3 section of the matrix, looking at the previous word, the next word, the previous sentence, and the next sentence to understand the context of the current word in the text. Before the filter can operate on the matrix, the matrix is zero padded. The size of the padding on each side of the matrix is 3//2=1, which results in a 7×7 matrix 510. The 3×3 filter begins at the top left corner of the matrix. When the filter is overlaid on top of the matrix 515, each value in the filter is multiplied by the corresponding value in the matrix. The resulting products are summed:

(0×1)+(0×0)+(0×1)+(0×0)+(1×1)+(0×0)+(0×1)+(1×0)+(0×1)=1

The value is inserted into the top-left cell of a result matrix 520. The 3×3 filter traverses the entire 7×7 matrix using a step size of 1, operating on each 3×3 section of the 7×7 matrix, resulting in a 5×5 result matrix 525, which are the original dimensions of the matrix before padding.

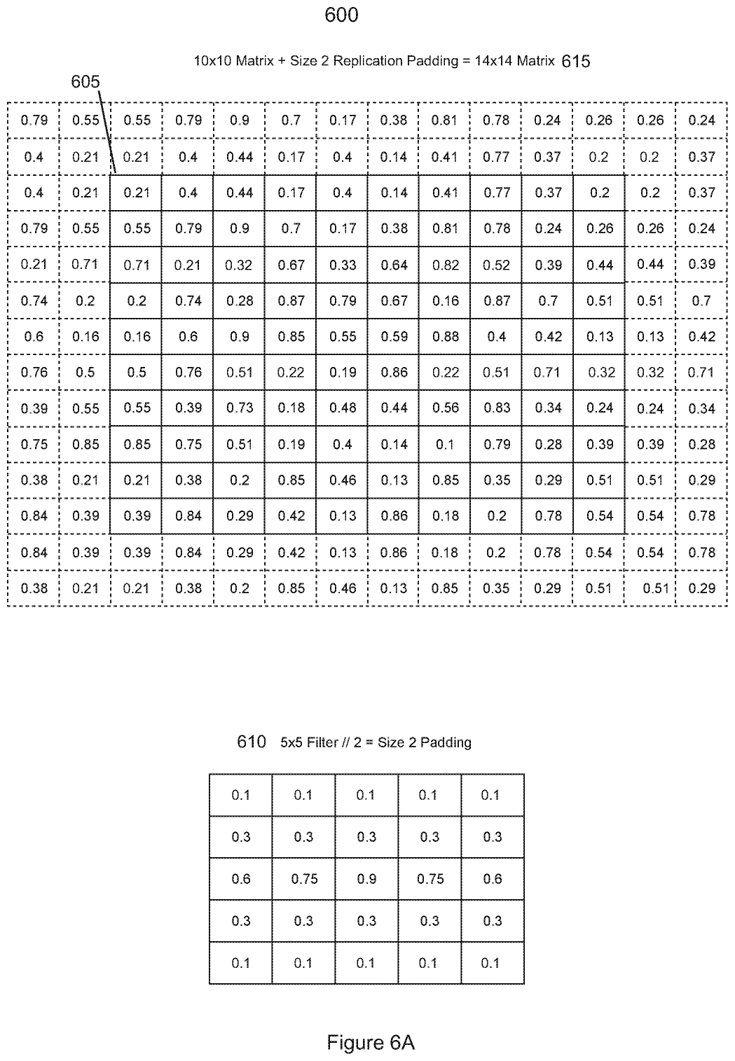

As illustrated in FIGS. 6a and 6b, matrices 600 used in the filter operation process depicted in FIG. 5, comprising a padded matrix, a filter, and the resulting matrix, are provided. In this example, the 10×10 matrix 605 and 5×5 filter 610 are more similar to an actual matrix and filter contemplated in the NED model. This example filter has a gradient in the scalar values
though in the case of vector entries, the gradient will be in the magnitudes of the vectors—with the highest values in the middle row, to give more weight to the current sentence, in comparison to the sentences before (above) and after (below). While multiple sentences are considered by the filter, the current sentence should be of most importance as reflected by the higher values. Additionally, within the current sentence, words closer to the current word are given more weight. Thus, the system is configured, for each word, to analyze and consider the tokens on both the left and right sides of the current word and the sentences before and after the current sentence to fully understand the context within the text. Before the filter can operate on the matrix, the matrix is padded with replication padding (5//2=2), which results in a 14×14 matrix 615. The 5×5 filter traverses the entire 14×14 matrix, operating on each 5×5 section of the matrix, resulting in a 10×10 result matrix 620.

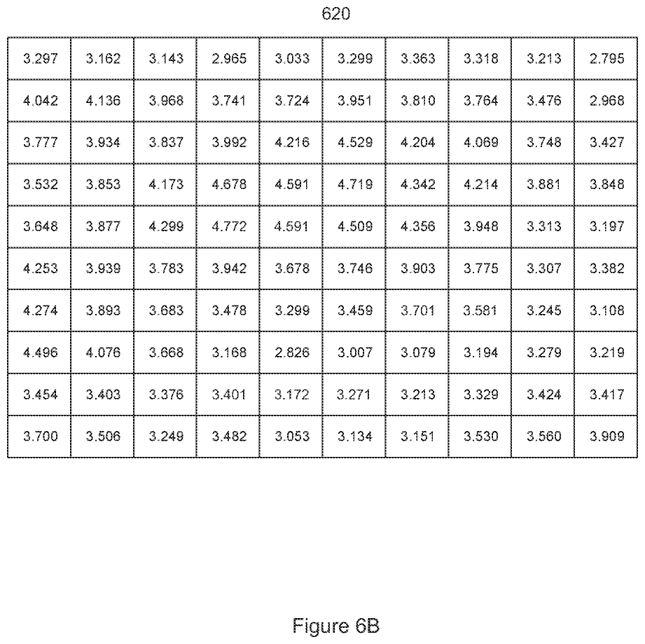

As depicted in FIG. 7, dynamic routing of capsule networks 700 is the process whereby connections between lower level and higher level capsules are activated based on relevance to each other in the Neural Capsule Entity Disambiguator. Before dynamic routing, each capsule in a lower layer 705 is connected to each capsule in the layer above 710. Over the course of training, extraneous connections between capsules in a lower layer 715 and the layer above 720 are identified and removed so that only the relevant connections remain. Although depicted as two dimensional, 2×3 (M×N) capsule layers, the capsules and capsule connections exist three dimensionally spanning the full depth (M×N×R) of the capsule layers. Capsules in a capsule layer can activate depending on their input data. Upon activation, the output of a lower capsule is routed to one or more capsules in the succeeding higher layer, abstracting away information while proceeding bottom-up. Capsules in a given capsule layer are configured to receive as input capsule outputs of one or more capsules of a previous capsule layer. The dynamic routing algorithm determines how to route outputs between capsule layers of the capsule network. As the capsules independently agree and converge to activate fewer and fewer higher level parent capsules, the overall complexity of the network at higher levels is reduced. Note that in a CapsNet, the higher layer capsules do not know what they represent in advance, so there is no prior assumption regarding the representations of higher layer capsules. Whereas for other architectures, such as those based on transformers, all layers have the same number of nodes, and the number of nodes is precisely the number of input tokens.

CapsNets are commonly employed in image recognition and classification due to their understanding of the spatial relationships of features in an image. For the image recognition process, CapsNet architecture involves capsules that take into consideration things like color, gradients, edges, shapes, and spatial orientation to identify object features and recognize the position and location of the features. As capsules agree on the features of the image, the output is routed to subsequent layers to the eventual identification of the image.

For NED, the disclosed model utilizes CapsNets trained to analyze the input by evaluating features of a token in the context of the input natural language text, such features including, but not limited to, part of speech tags and dependency relations. In the preferred embodiment, where the model also performs NER, the disclosed CapsNet is trained to identify a named entity by evaluating features of a token in the context of the input natural language text, such features including, but not limited to, part of speech tags, constituency parsing, relations between words, and conjunctions, and group a named entity into clusters by evaluating features of the named entity in the context of the input natural language text, such features including, but not limited to, dependency relations, prepositions, and object types. The features are considered by the model through the capsules in the M×N×R matrix as the filters operate on the matrix at each layer. As capsules agree on the features of the words used to identify, cluster, and disambiguate a named entity, the output is routed to subsequent layers. Dynamic routing of capsule networks ensures that connections between higher layer and lower layer capsules are based on relevance to each other, thus removing all irrelevant activations and reducing the overall complexity of the network.

As depicted in FIG. 2, the matrix outputted by the Neural Capsule Entity Disambiguator is passed through a Neural Network Layer 244, which can comprise one or more computers, components, or program modules and can reside local to the Neural Capsule Entity Disambiguator 202 or separate. The Neural Network Layer performs a function that transforms and normalizes the values in the matrix. This can be done by a sigmoid function, which produces values ranging between 0 and 1, or tan h function, which produces values ranging between −1 and 1, but other functions may be performed, and no limitation is intended. The values in the matrix are mathematically scaled 246 to integers, where 0 indicates not a named entity and integers greater than 0 indicate the entity's ID number. If the range of values after the Neural Network Layer is 0 to 1, this can be performed with scalar multiplication. In some embodiments, as part of the mathematical scaling, a ceiling function or some other rounding function can be used to ensure that the mathematical scaling results in integer values. A ceiling function would be preferred to a floor function to prevent values below 1 that should be recognized as an NE from being rounded to 0 and thus not recognized as a named entity. In alternative embodiments, the Neural Network Layer and mathematical scaling functionalities can be performed by the Neural Capsule Entity Disambiguator or after each layer in the Neural Capsule Entity Disambiguator.

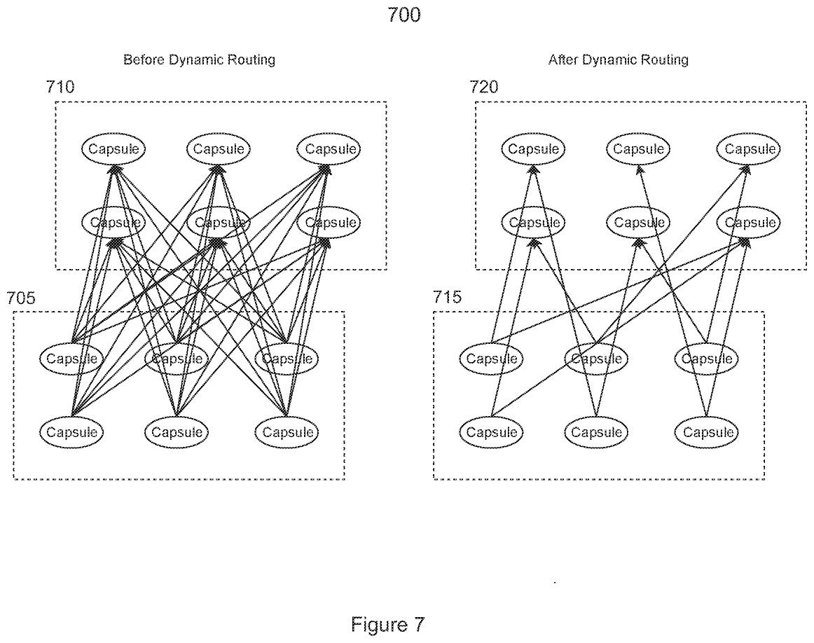

The output of the Neural Network Layer is a three dimensional matrix 248 of dimensions M (number of sentences)×N (maximum sentence length)×defined maximum number of clusters. The matrix is converted to a two dimensional final output matrix 250. As illustrated in FIG. 8, this final output matrix 800 is created by taking each sentence and appending it to the end of the prior sentence, removing all 0 embeddings inserted when the input was converted to an M×N matrix. This results in a two dimensional matrix having dimensions of the defined maximum number of clusters x the input string length. The values in this matrix are either 0, indicating that the word is not a named entity, or an integer greater than 0, identifying that entity's unique ID number. In the output produced from the example text, “John Smith is an artist. John likes to paint,” the columns 805 correspond to the locations of the words in the input string, and the rows 810 correspond to named entity class clusters. “John” and “John Smith” both have ID 25 and are in the name/person cluster, which identifies that both “John” and “John Smith” refer to the same person. Additionally, “artist” has ID 200 and is in the profession cluster, and “paint” has ID 17 and is in the activity cluster. In some embodiments, the clusters are limited to a predefined, smaller set of broad named entity classes. Alternatively, the clusters are groupings where the categories are later identified through post-processing. Other forms of post-processing can include labeling or identification of clusters, expansion or splitting of clusters, and consolidation or combining of clusters. The IDs can be from a limited predefined smaller set of named entities, or can be later identified through post-processing from a knowledge base.

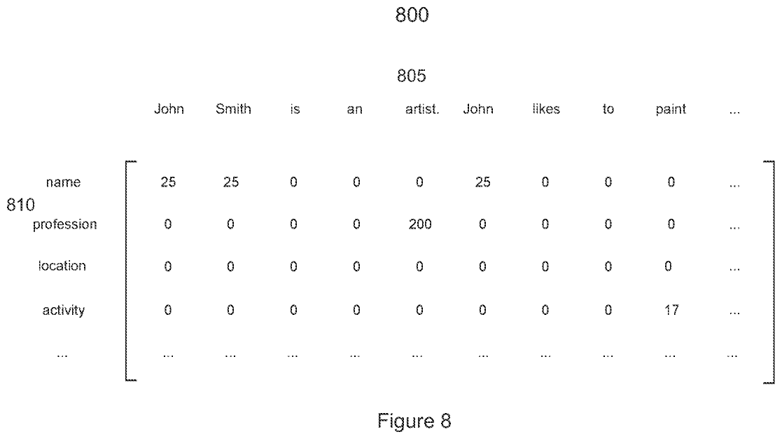

As illustrated in FIG. 9, an alternative two dimensional output matrix 900 having dimensions of the number of clusters identified in the input string 910×the input string length 905, is provided. This differs from the matrix depicted in FIG. 8 in that rows/clusters are removed if no named entities belonging to those clusters are identified in the input string. Using the example text, “John Smith is an artist. John likes to paint,” because there is no named entity from the location cluster, the third row, containing 0s for the entire row, has been removed from the output matrix. The removal of rows results in named entities appearing in rows where the row number does not accurately identify the cluster to which it belongs. To preserve the cluster number for the row, the rows are labeled with the correct cluster number. In FIG. 9, the removal of the location cluster results in “paint” appearing in the third row of the matrix even though it belongs to the fourth cluster. The third row (cluster) is labeled with the activity cluster number, 4, since the row number no longer identifies the cluster.

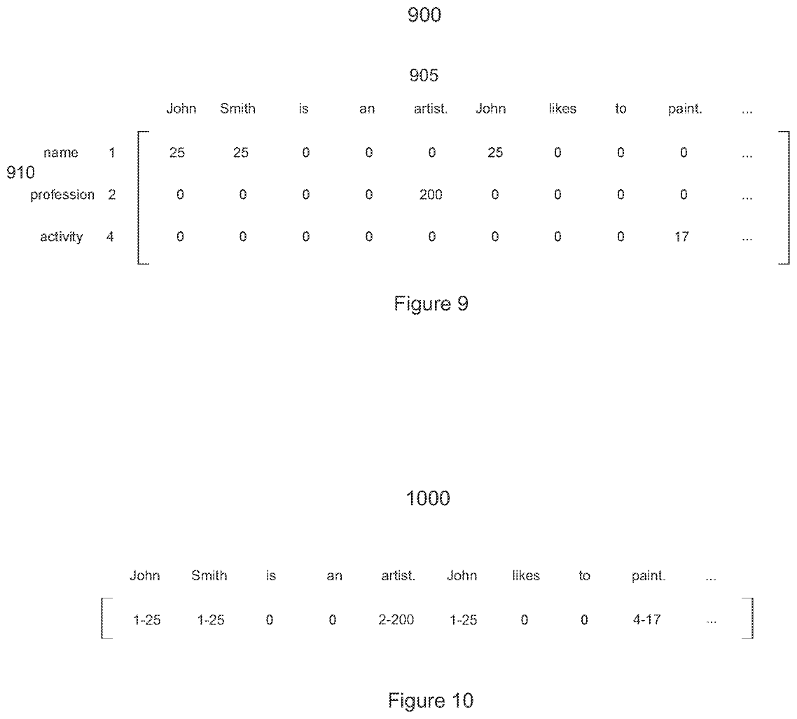

Because this disclosure contemplates the performance of NED without the simultaneous or prior performance of NER, the class to which a named entity belongs may not be known and consequently cannot be included as part of the output. In such an embodiment, the output can be a vector corresponding to the input text. Each entry in the vector is tagged as either 0, indicating that the word is not a named entity, or an integer greater than 0, identifying that entity's unique ID number. The IDs can be from a limited predefined smaller set of named entities, or can be later identified through post-processing from a knowledge base. When NER is performed in addition to NED, a vector output can be created that either does not indicate the cluster to which the named entity belongs or indicates the cluster through other means. As depicted in FIG. 10, an output vector 1000, that indicates a named entity's cluster and ID, is provided. The vector value for “paint” is shown as 4-17 to indicate that it is in the fourth cluster, the activity cluster, in addition to its entity ID of 17. Other outputs may be created by the model or through post-processing, and no limitation is intended by the described outputs.

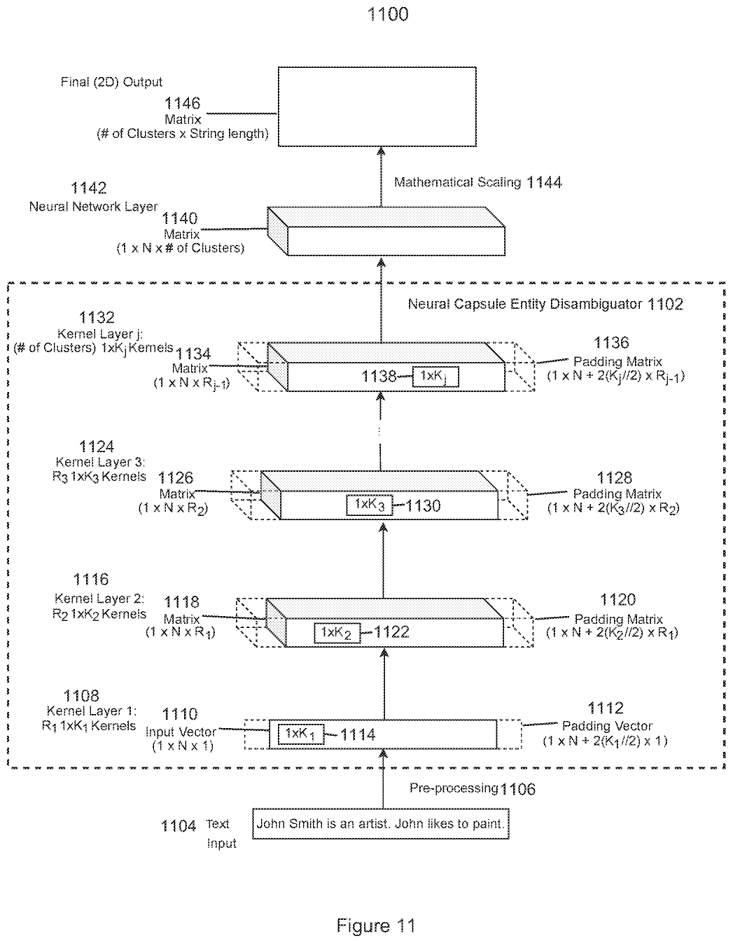

As illustrated in FIG. 11, an alternative Named Entity Disambiguator embodiment 1100, configured to identify, cluster, and disambiguate named entities without the use of a two dimensional matrix, is provided. The input text 1104 is converted to a 1×I_{L} embedding vector in pre-processing 1106. Instead of creating an M×N matrix, where M is the number of sentences and N is the maximum sentence length, the input remains a vector. The vector can be treated as a single sentence M×N matrix, though it remains a vector of dimensions 1×N and may be comprised of more than one sentence. The 1×N vector is converted into a 1×N×R matrix, where R is 1. The Neural Capsule Entity Disambiguator 1102 has layers of 1×Kᵢ filters that will pass over the entire 1×N×R matrix, where the Kᵢ filter size varies at each layer. The system is configured, for each word, to analyze and consider the tokens on both the left and right sides of the current word to fully understand the context within the text. Each 1×Kᵢ filter will run through the full depth of the 1×N×R matrix creating one layer of depth in the next 1×N×R output. At each layer, padding of size Kᵢ//2 will be added to both ends of the matrix, resulting in a matrix of size 1×N+2(Kᵢ//2)×R.

As depicted in FIG. 11, at each layer, a series of 1×Kᵢ filters (kernels) operate on the 1×N×R matrix. At the first layer 1108, the input 1×N×1 vector 1110 is padded to be 1×N+2(K₁//2)×1 1112, where K₁ is the dimension of the filters at the first layer. R₁ 1×K₁ filters 1114 operate on the vector resulting in a matrix of dimensions 1×N×R₁, where R₁ is the number of filters at the first layer. At the second layer 1116, the 1×N×R₁ matrix 1118 is padded to be 1×N+2(K₂//2)×R₁ 1120, where K₂ is the dimension of the filter. R₂ 1×K₂ filters 1122 operate on the matrix resulting in a matrix of dimensions 1×N×R₂, where R₂ is the number of filters at the second layer. At the third layer 1124, the 1×N×R₂ matrix 1126 is padded to be 1×N+2(K₃//2)×R₂ 1128, where K₃ is the dimension of the filter. R₃ 1×K₃ filters 1130 operate on the matrix resulting in a matrix of dimensions 1×N×R₃, where R₃ is the number of filters at the third layer. This process continues for each layer in the Neural Capsule Entity Disambiguator as an increasing number of filters operates on the matrix at each layer. At the final layer 1132, the j^{th} layer, the 1×N×Rⱼ₋₁ matrix 1134 is padded to be 1×N+2(Kⱼ//2)×Rⱼ₋₁ 1136, where Kⱼ is the dimension of the filters at the last layer. 1×Kⱼ filters 1138 operate on the matrix, where the number of filters at the final layer is equal to the defined maximum number of clusters, resulting in a matrix of dimensions 1×N×defined maximum number of clusters 1140. This disclosure contemplates the performance of NED without NER. In such an embodiment, the defined maximum number of clusters would still be a hyperparameter that determines the number of filters used by the model, even though the creation of named entity clusters would not take place.

The matrix is passed through a Neural Network Layer 1142 and mathematical scaling 1144 is performed. The final output matrix 1146 is a two dimensional matrix of dimensions the defined maximum number of clusters x the input string length. The values in this matrix are either 0, indicating that the word is not a named entity, or an integer greater than 1 identifying that entity's ID number, where the location in the matrix corresponds to the entity's cluster (row) and position in the input (column). Other outputs are contemplated by this disclosure, and no limitation is intended by the described outputs.

The preceding description contains embodiments of the invention, and no limitation of the scope is thereby intended. It will be further apparent to those skilled in the art that various modifications and variations can be made in the present invention without departing from the spirit or scope of the invention.

1. A computer-implemented method for named entity disambiguation, comprising:
receiving, into a neural capsule embedding network as input, an embedding matrix, wherein the embedding matrix contains embeddings representing words in a natural language text and each row in the matrix is an embedding sentence;
analyzing, by the neural capsule embedding network, the features of each word in context of the embedding matrix considering tokens to the left and right of the word and the sentences before and after the sentence of the word using at least one layer, each layer consisting of at least one set of filters;
through dynamic routing of capsules, by the neural capsule embedding network, converging to a final capsule layer mapping to each word in the input matrix;
generating, by the neural capsule embedding network, an output matrix, wherein each output matrix value:
a) identifies if a word in the input is a named entity or not a named entity;
b) if the word is a named entity, identifies a unique ID number of the entity.

2. The method of claim 1 further comprising:
before receiving, into a neural capsule embedding network as input, an embedding matrix:
a) receiving, as input, a natural language text;
b) converting words in the natural language text into embeddings and inserting an embedding sentence into each row in the matrix.

3. The method of claim 1 further comprising:
before receiving, into a neural capsule embedding network as input, an embedding matrix:
a) receiving, as input, a natural language text;
b) converting words in the natural language text into embeddings and inserting embeddings into an embedding vector;
c) converting the embedding vector to an embedding matrix by inserting an embedding sentence into each row in the matrix.

4. The method of claim 1, further comprising:
after receiving, into a neural capsule embedding network as input, an embedding matrix, deriving, by the neural capsule embedding network, features of each word in the context of the natural language text.

5. The method of claim 1 further comprising:
before receiving, into a neural capsule embedding network as input, an embedding matrix:
a) receiving, as input, a natural language text;
b) pre-processing the natural language text to identify features of the natural language text;
c) converting words in the natural language text into embeddings and inserting an embedding sentence into each row in the matrix.

6. The method of claim 1 further comprising:
before receiving, into a neural capsule embedding network as input, an embedding matrix:
a) receiving, as input, a natural language text;
b) pre-processing the natural language text to identify features of the natural language text;
c) converting words in the natural language text into embeddings and inserting embeddings into an embedding vector;
d) converting the embedding vector to an embedding matrix by inserting an embedding sentence into each row in the matrix.

7. The method of claim 1, wherein, the output matrix columns correspond to the locations of the words in the input string, and the output matrix rows correspond to named entity classes.

8. The method of claim 7, wherein the named entity classes are a predefined set of named entity classes.

9. The method of claim 7, wherein the named entity classes are clusters determined by the neural capsule embedding network.

10. The method of claim 1, wherein unique ID numbers are a predefined set of named entity IDs.

11. The method of claim 1, wherein unique ID numbers are determined by the neural capsule embedding network.

12. The method of claim 1, further comprising where each output matrix value:
if the word is a named entity, identifies what class the named entity belongs to.

13. The method of claim 1, wherein through dynamic routing of capsules, capsules agree on the features of words used to disambiguate a named entity.

14. The method of claim 1, wherein through dynamic routing of capsules, capsules agree on the features of words used to identify, classify, and disambiguate a named entity.

15. A computer-implemented method for named entity disambiguation, comprising:
receiving, into a neural capsule embedding network as input, an embedding vector, wherein the embedding vector contains embeddings representing words in a natural language text;
converting, by the neural capsule network, the embedding vector to an embedding matrix, by inserting an embedding sentence into each row in the matrix;
analyzing, by the neural capsule embedding network, the features of each word in context of the embedding matrix considering tokens to the left and right of the word and the sentences before and after the sentence of the word using at least one layer, each layer consisting of at least one set of filters;
through dynamic routing of capsules, by the neural capsule embedding network, converging to a final capsule layer mapping to each word in the input vector;
generating, by the neural capsule embedding network, an output matrix, wherein each output matrix value:
a) identifies if a word in the input is a named entity or not a named entity;
b) if the word is a named entity, identifies a unique ID number of the entity.

16. The method of claim 15 further comprising:
before receiving, into a neural capsule embedding network, an embedding vector as input:
a) receiving, as input, a natural language text;
b) converting words in the natural language text into embeddings and inserting embeddings into an embedding vector.

17. The method of claim 15 further comprising:
before receiving, into a neural capsule embedding network, an embedding vector as input:
a) receiving as input a natural language text;
b) pre-processing the natural language text to identify features of the natural language text;
c) converting words in the natural language text into embeddings to include in an embedding vector.

18. A computer-implemented method for named entity disambiguation, comprising:
receiving, into a neural capsule embedding network as input, an embedding vector, wherein the embedding vector contains embeddings representing words in a natural language text;
analyzing, by the neural capsule embedding network, the features of each word in context of the embedding vector considering tokens to the left and right of the word using at least one layer, each layer consisting of at least one set of filters;
through dynamic routing of capsules, by the neural capsule embedding network, converging to a final capsule layer mapping to each word in the input vector;
generating, by the neural capsule embedding network, an output vector, wherein each output vector value:
a) identifies if a word in the input is a named entity or not a named entity;
b) if the word is a named entity, identifies a unique ID number of the entity.

19. The method of claim 18 further comprising:
before receiving, into a neural capsule embedding network, an embedding vector as input:
a) receiving, as input, a natural language text;
b) converting words in the natural language text into embeddings and inserting embeddings into an embedding vector.

20. The method of claim 18 further comprising:
before receiving, into a neural capsule embedding network, an embedding vector as input:
a) receiving as input a natural language text;
b) pre-processing the natural language text to identify features of the natural language text;
c) converting words in the natural language text into embeddings to include in an embedding vector.
